SEQUENCE LISTING (3 sequences)

SEQ ID NO: 1 - RNA, 62 nt, artificial
  illustrative sequence
uuagccguaaugugcgcuaauuacauagcccaauuuugguauuauaaacguauaguggcgca

SEQ ID NO: 2 - RNA, 46 nt, artificial
  illustrative sequence
augugcgcuaauuacauggcccaauuuugguaucauaaacguauag

SEQ ID NO: 3 - RNA, 46 nt, artificial
  illustrative sequence
augugcgcuaauuacauggcccaauuuugguauuauaaacguauag

(19) United States
(12) Patent Application Publication
(10) Pub. No.: US 2018/0068059 A1
(43) Pub. Date: Mar. 8, 2018

(54) MALICIOUS SEQUENCE DETECTION FOR GENE SYNTHESIZERS

(71) Applicant: SAP SE, Walldorf (DE)

(72) Inventors: Jens Odenheimer, Walldorf (DE); Udo Klein, Walldorf (DE)

(21) Appl. No.: 15/259,420

(22) Filed: Sep. 8, 2016

(51) Int. Cl. G06F 19/22; G06F 17/30

(52) U.S. Cl. CPC G06F 19/22; G06F 17/30424

(57) ABSTRACT

In a process of malicious sequence detection for gene synthesizer, a sequence is received as input in the gene synthesizer. A sequence of interest is isolated from the received sequence. The sequence of interest is encoded using an encoding mechanism. The encoded sequence of interest is received as input in a locality sensitive hasher. A hash is generated corresponding to the sequence of interest. The hash is matched with malicious hashes stored in a database. Upon determining a match between the hash and a malicious hash, a similarity score is computed between the hash and the malicious hash. It is determined whether the similarity score is above a threshold score. Upon determining that the similarity score is above the threshold score, the sequence of interest is identified as malicious sequence and is prevented from synthesis.

### FIELD

Illustrated embodiments generally relate to data processing, and more particularly to malicious sequence detection for gene synthesizers.

### BACKGROUND

Bioinformatics is an interdisciplinary field where software programs are developed to process and understand biological data. Bioinformatics is used to understand the protein sequences at a greater level of detail. With innovations in modern molecular biology, synthesizing such protein sequences is relatively easier. Software programs may be used to understand the protein sequences, and identify a specific protein sequence and synthesize. When the software programs provide access to the protein sequences without restriction, there is a possibility of a potential abuse of the software program to identify and synthesis a malicious sequence such as an epidemic virus or bacteria. If there is a slight variation in the protein sequences, the software program may not be able to identify the malicious sequence. Thus it is challenging to provide software programs with access to protein sequences for analysis and to identify a varied malicious sequence, and also restrict synthesis of the malicious sequences.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1A and FIG. 1B in combination illustrates high-level overview of a process for malicious sequence detection by a gene synthesizer, according to one embodiment.

FIG. 2A and 2B in combination illustrates an example to detect malicious sequence in gene synthesizer, according to one embodiment.

FIG. 3 is a block diagram illustrating process of malicious sequence detection for gene synthesizer, according to one embodiment.

FIG. 4 is a flow chart illustrating process of malicious sequence detection for gene synthesizer, according to one embodiment.

FIG. 5 is a block diagram illustrating an exemplary computer system, according to one embodiment.

### DETAILED DESCRIPTION

Embodiments of techniques for malicious sequence detection for gene synthesizers are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Deoxyribonucleic (DNA) and ribonucleic acid (RNA) are nucleic acids that express genes associated with living organisms. Artificial gene synthesis is a method used to create artificial genes in laboratory based on the DNA and RNA. Translation is a process by which a protein is synthesized from information contained in RNA. Sequence may be either a DNA/RNA sequence or a protein sequence. For example, DNA/RNA sequencing determines the sequence of individual genes. Sequence may be represented as alphabets.

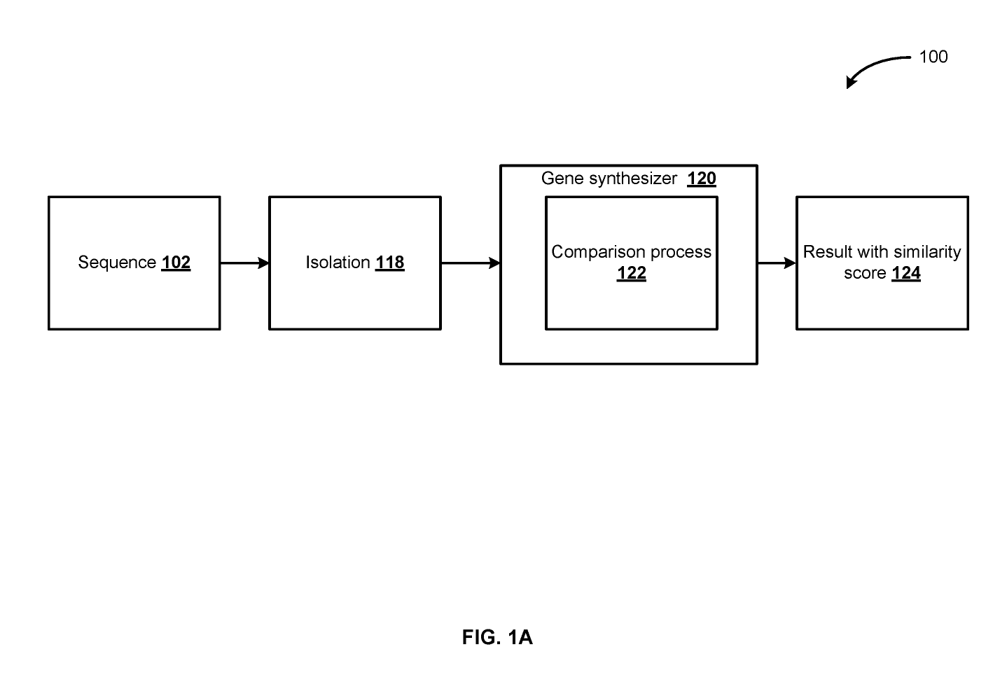

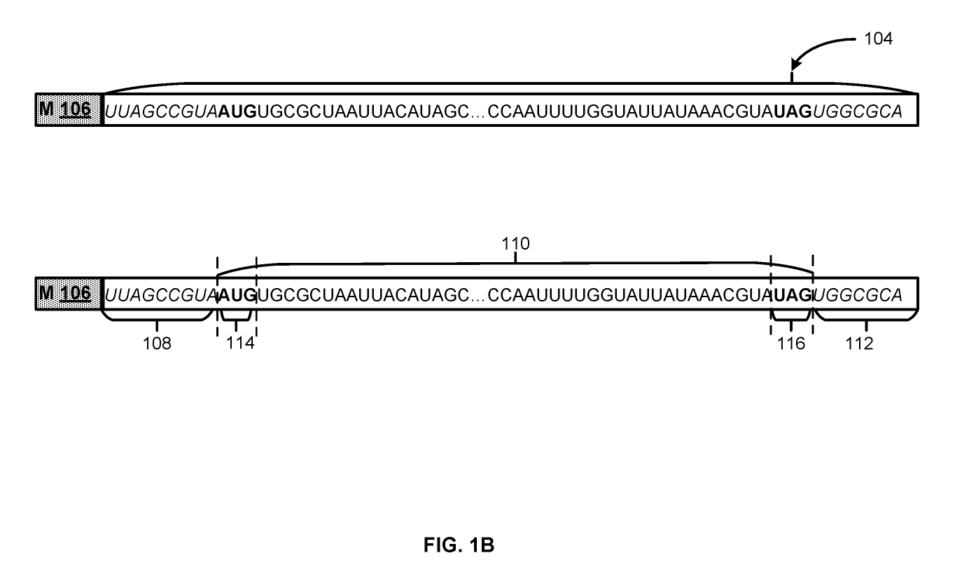

FIG. 1A and FIG. 1B in combination illustrates high-level overview of a process for malicious sequence detection by a gene synthesizer, according to one embodiment. In block diagram 100, sequence 102 may be received as an input in the process of sequence detection in gene synthesizer. Sequence 102 may be a DNA sequence, RNA sequence, protein sequence, etc. For example, sequence 102 may be RNA sequence 104 represented by ‘M’ 106 as shown FIG. 1B. The RNA sequence 104 consists of three parts primer 108, coding sequence or gene 110, and suffix 112. Primer 108 is a sequence that serves as a starting point for DNA/ RNA synthesis. Primer is also referred to as a non-coding sequence. Sequencing machine manufacturers provide libraries of known primers. When the primer is known in a sequence, the primer may be removed from the sequence to be analyzed. When the primer is not known in a sequence, codon is identified. A codon is a specific sequence of three adjacent nucleotides on a strand of DNA or RNA that specifies the genetic code information for synthesizing the DNA or RNA. A start codon is the first codon that indicates the start of a gene sequence. Some examples of start codons are ‘AUG’, ‘CUG’, ‘AUA, ‘AUU’, ‘CUG’ and ‘UUG’. A stop codon is the last codon that indicates the termination of the gene sequence. Some examples of stop codon are ‘UAG’, ‘UAA’ and ‘UGA’. In the portion of sequence representing gene 110, ‘AUG’ represents the start codon 114, and TAG' represents the stop codon 116. The sequence of interest for analysis is the sequence-representing gene 110 including the start codon 114 and the stop codon 116. In a scenario where primer is not known, isolation process of the gene sequence includes identification of the start codon 114 and the stop codon 116, and determining the sequence 110 as the sequence of interest.

Isolation process 118 in FIG. 1A involves analyzing the sequence 102 to identify primer and suffix, or start and stop codons, and removing the primer and the suffix, or start and stop codons from the sequence 102. Primers that are known may be available in a library. The known list of primers is matched with the sequence 102, to identify the portion of sequence constituting a primer. Similarly, the sequence 102 is matched with a known list of suffixes, to identify the portion of sequence constituting a suffix. When a match is identified for the primer and suffix in the sequence 102, the primer and suffix are removed from the sequence 102, and the sequence of interest or gene is isolated for analysis. In a scenario where the primer and suffix are not known, the sequence 102 is analyzed to identify start codon and stop codon. The sequence 102 is analyzed to identify start codon and stop codon, and isolate the gene from the start codon until the stop codon for analysis.

The sequence of interest or gene is provided to gene synthesizer 120. Gene synthesizer 120 may be a combination of hardware and software application, enabling synthesis of DNA, RNA, etc. In the comparison process 122 in the gene synthesizer 120, the isolated gene sequence is translated using an encoding mechanism such as base 4 encoding, so that the sequence is in a compact form for analysis. Any other encoding mechanisms such as UTF may lead to four times longer string sequence. The sequence translated using the base 4 encoding format is represented as bit binary encoding. Sliding window technique is used to parse the bit binary encoding. Sliding window technique is used to parse two bits at a time i.e., one character at a time. The parsed bit sequence is input to a locality sensitive hasher (LSH). Sliding window approach is used to parse a portion of sequence or a set of bits, and add it to an array of bucket. The parsed bit sequence is compared with the previously stored sequence or set of bits to determine a match. If a match is determined, number of times the match occurred is also stored. Hash of the sequence of interest is generated based on bit binary encoding, array of bucket, etc.

The generated hash is compared with a list of malicious hashes corresponding to malicious sequences to identify a match. Based on the extent of match a similarity score is computed, and a result with similarity score 124 is displayed in a user interface. If the similarity score is above a threshold score, the sequence of interest or gene is determined to be malicious and is sent for further analysis. The threshold score may be a user-defined threshold or pre-defined threshold score that can be dynamically varied before analysis of sequences. The sequence of interest is prevented from being synthesized. Since the original malicious sequences are not stored in any database, users may not have direct access to the malicious sequences. Thus legal requirements are complied. Even if the sequence of interest is a variant such as phenotype of any malicious sequence, the LSH is capable of identifying them.

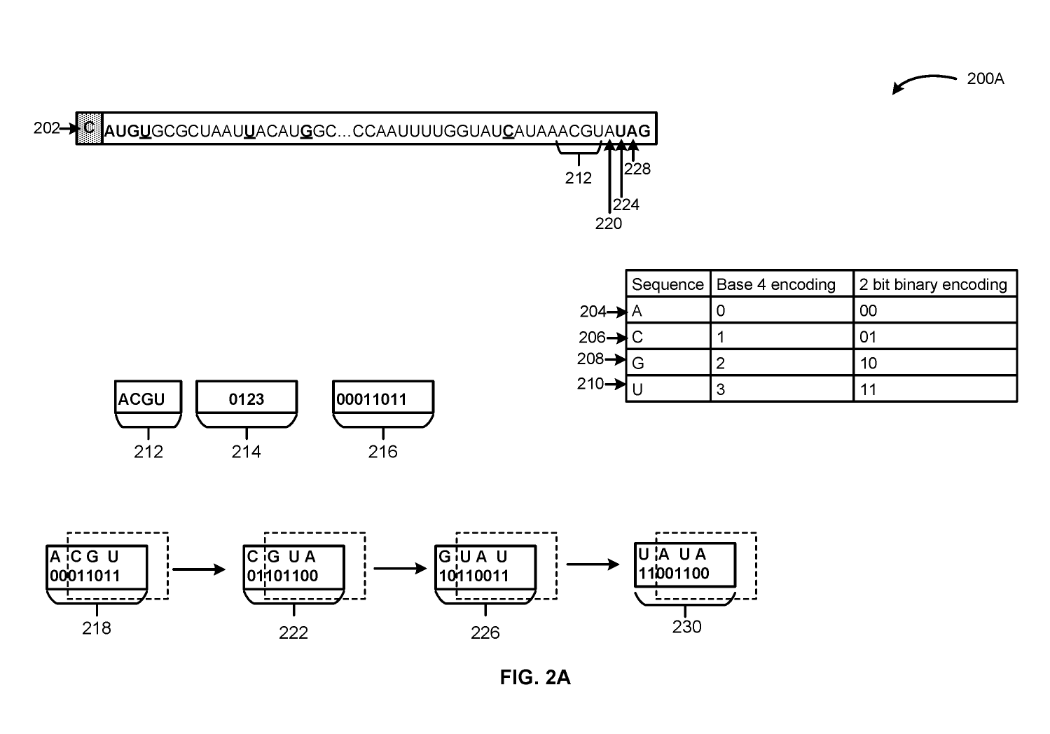

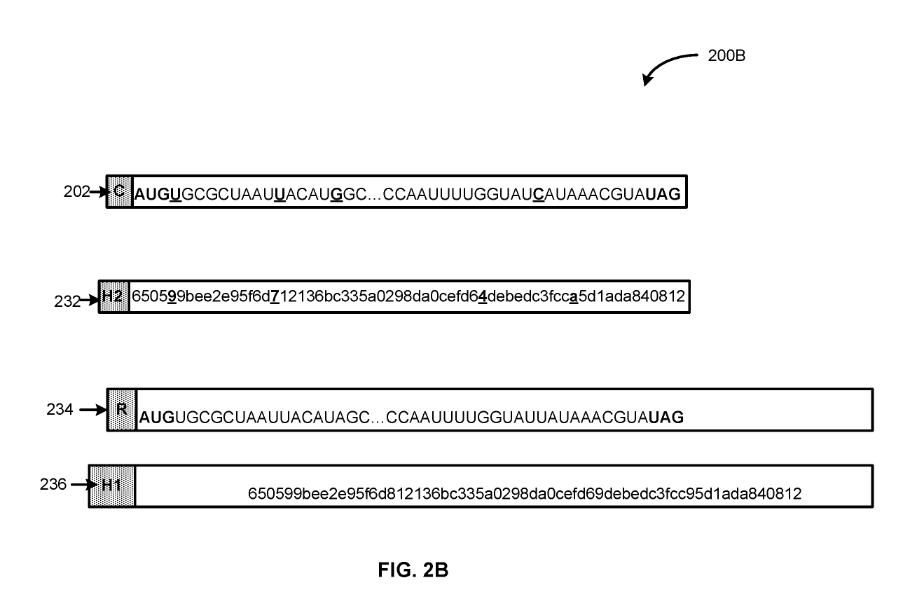

FIG. 2A and 2B in combination illustrates example 200A and 200B to detect malicious sequence in gene synthesizer, according to one embodiment. Sequence ‘C’ 202 is received for analysis to determine if sequence ‘C’ 202 is a malicious sequence or not. The sequence ‘C’ 202 is translated using an encoding mechanism such as a base 4 encoding, and this base 4 encoding may be stored as a 2 bit binary encoding. Accordingly, character ‘A’ in sequence ‘C’ 202 is translated to base 4 encoding ‘0’, and this is represented as 2 bit binary encoding ‘00’ as shown in row 204, character ‘C’ in sequence ‘C’ 202 is translated to base 4 encoding ‘1’, and this represented as 2 bit binary encoding ‘01’ as shown in row 206. Character ‘G’ in sequence ‘C’ 206 is translated to base 4 encoding ‘2’, and this is represented as 2 bit binary encoding ‘10’ as shown in row 208, and similarly, character ‘U’ in sequence ‘C’ 202 is translated to base 4 encoding ‘3’, and this represented as 2bit binary encoding ‘11’ as shown in row 210.

Consider a portion of sequence ‘ACGU’ 212, the base 4 encoding corresponding to this portion is ‘0123’ 214, and the bit binary encoding is ‘00011011’ 216. The bit binary encoding ‘00011011’ 216 is 8 bits long, and these 8 bits represent one byte. Sliding window technique is used to perform byte level parsing of the binary encoding ‘00011011’ 216. The sequence ‘ACGU’ 212 represented by bit binary encoding ‘00011011’ 216 has to be parsed one character at a time. But in sliding window technique of byte level parsing, the sequence ‘ACGU’ 212 represented by bit binary encoding ‘00011011’ 216 is parsed four characters at a time. Therefore, when the bit binary encoding ‘00011011’ 216 is parsed using the sliding window technique, the bit binary encoding ‘00011011’ 216 is shifted by 2bits, as shown in 218. The binary encoding ‘00011011’ 218 is shifted by 2bits ‘00’, and the next 2bits ‘00’ corresponding to character ‘A’ 220 in sequence ‘C’ 202 is concatenated at the end of the bit binary encoding as shown in 222. The sliding window parses or slides the binary encoding ‘01101100’ 222. The bit binary encoding ‘01101100’ 222 is shifted by 2bits ‘01’, and the next 2 bits ‘11’ corresponding to the character ‘U’ 224 in sequence ‘C’ 202 is concatenated at the end of the bit binary encoding as shown in 226. The sliding window parses or slides the binary encoding ‘10110011’ 226. The binary encoding ‘10110011’ 226 is shifted by 2bits ‘10’, and the next 2bits ‘00’ corresponding to character ‘A’ 228 in sequence ‘C’ 202 is concatenated at the end of the binary encoding as shown in ‘11001100’ 230. The sliding window parses or slides the bit binary encoding ‘1100100’ 230. Alternating between sliding the bit binary encoding and shifting two bits, results in parsing two bits at a time i.e., one character from the sequence at a time. This process continues until the complete sequence is parsed.

The parsed binary encoding string is an input to locality sensitive hasher (LSH). LSH identifies similarities between objects using probability distributions over hash functions. Similar inputs are likely to have same or similar hashes. Accordingly, even if the sequences vary slightly or if the sequences are similar, the sequences are likely to have similar hashes. Various algorithms or hash functions may be used in LSH. In the illustration below, ternary locality sensitive hashing (TLSH) function may be used. In the TLSH function, sliding window approach is used to slide or parse a sequence of 5 bytes i.e., 20 characters at a particular instance or time to populate an array of bucket. The parsed sliding window content is compared with previously stored sliding window content in the array of bucket to determine if a match may be identified. If the parsed sliding window content does not match the previously stored sliding window content in the array of bucket, the contents of the parsed sliding window content is added to a new bucket in the array of bucket, and parsing of the binary bit encoding using the sliding window is continued.

If parsed window content matches any entry in the array of bucket, number of times the match is identified is also determined in the array of bucket count. This process is iteratively continued until the bit binary encoding is parsed using the sliding window approach, and the contents of the sliding window are added to the array of bucket. The Quartiles of the array of bucket are computed such that 75% of the array bucket counts are greater than or equal to first quartile (q₁), 50% of the array bucket counts are greater than or equal to second quartile (q₂), and 25% of the array bucket counts are greater than or equal to third quartile (q₃). Quartile is a type of quantile, where q₁ is defined as the middle number between the smallest array of bucket count and median of the array of bucket counts. Q₂ is defined as the median of the bucket counts. Q₃ is the middle value between the median and the highest value of the bucket counts. Hash is generated based on the bit binary encoding, quartiles q₁, q₂q₃, array of bucket, etc., as shown in hash ‘H2’ 232 in FIG. 2B.

Consider a malicious RNA sequence ‘R’ 234, and a hash ‘H1’ 236 generated for the sequence ‘R’ 234 as shown in FIG. 2B. Hash ‘H1’ 236 is stored in a database for comparison and processing, and the original malicious sequence ‘R’ 234 is not stored in the database. Hash ‘H2’ 232 of the sequence ‘C’ 202 is compared with the hash ‘H1’ 236 of the malicious sequence ‘R’ 234. Sequence ‘C’ 202 and sequence ‘R’ 234 vary in certain characters, similarly, hash ‘H2’ 232 and hash ‘H1’ 236 vary in certain hash characters. Even if there are variations in the sequence ‘C’ 202 or if the sequence ‘C’ 202 is disguised, LSH scanner identifies that sequence ‘C’ 202 is similar to the malicious sequence ‘R’ 234 by comparing their respective hashes. Similarity may be determined by computing similarity score. The similarity score may be computed using any algorithm or technique such as jaccard index. Jaccard index is a statistic used for comparing the similarity of the data set. In the above case, comparison of hash ‘H2’ 232 and hash ‘H1’ 236 results in a similarity score of 0.95. Since there is a 95% match between the hashes ‘H2’ 232 and ‘H1’ 236, the sequence ‘C’ 202 is subject to further analysis and is prevented from synthesis. A specific similarity score may be determined to be a threshold or a user-defined threshold score. If the generated similarity score is below the user-defined threshold score, the sequence is not subject to further analysis. If the generated similarity score is above the user-defined threshold score, the sequence is subject to further analysis.

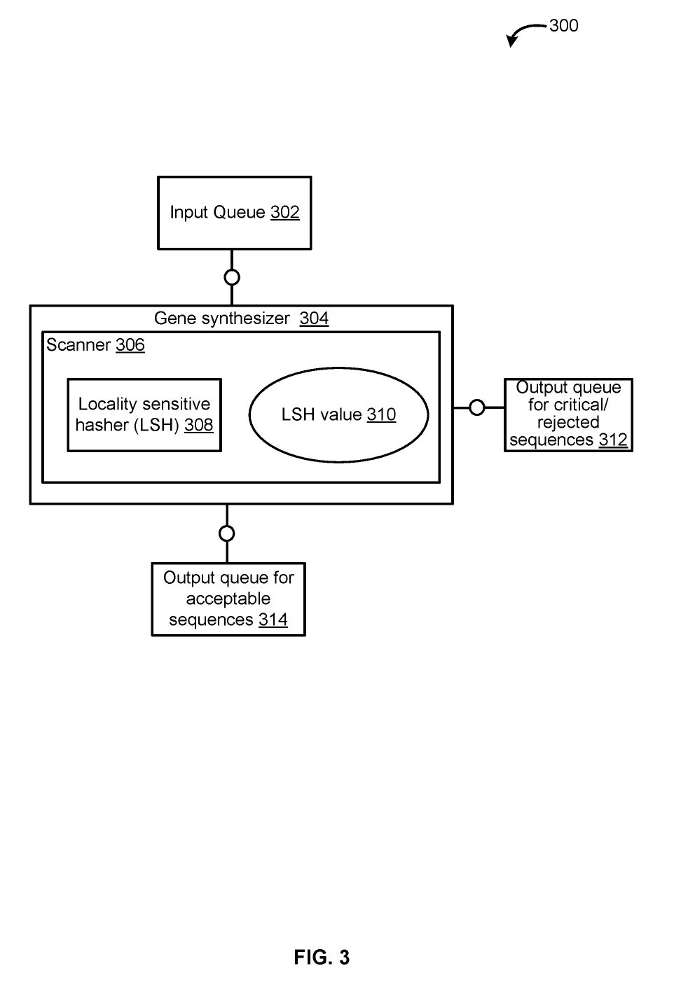

FIG. 3 is block diagram 300 illustrating process of malicious sequence detection for gene synthesizer, according to one embodiment. In the process of detecting malicious sequence, a sequence may be received as an input in input queue 302. The sequence is analyzed to identify primer and suffix, or start and stop codons to isolate a sequence of interest or gene. The sequence of interest or gene in the input queue 302 is provided as an input to the gene synthesizer 304. Gene synthesizer 304 may be a combination of hardware and software application enabling synthesis of the sequence of interest. Scanner 306 in the gene synthesizer 304 scans the received input queue 302 to determine whether the received sequence of interest is malicious or non-malicious. The sequence of interest is translated using an encoding mechanism such as base 4 encoding, and is represented as bit binary encoding such as 2bit sequences. Sliding window technique is used to parse the bit binary encoding. The parsed bit sequences are input to a locality sensitive hasher (LSH) 308.

LSH 308 parses the bit sequences, and generates a hash value referred to as LSH value 310. The LSH value 310 may be generated for a complete sequence or a portion of sequence or sub-sequence. The generated LSH value 310 is compared with a list of malicious hashes corresponding to malicious sequences to identify a match. Based on the extent of match, a similarity score is computed. A user or an application may define a threshold of similarity score. If the computed similarity score is above the user-defined threshold of similarity score, the sequence of interest or gene is determined to be malicious, and is sent to output queue for critical/rejected sequences 312. If the computed similarity score is below the user-defined threshold of similarity score, the sequence of interest or gene is determined or identified to be non-malicious, and is sent to output queue for acceptable sequences 314.

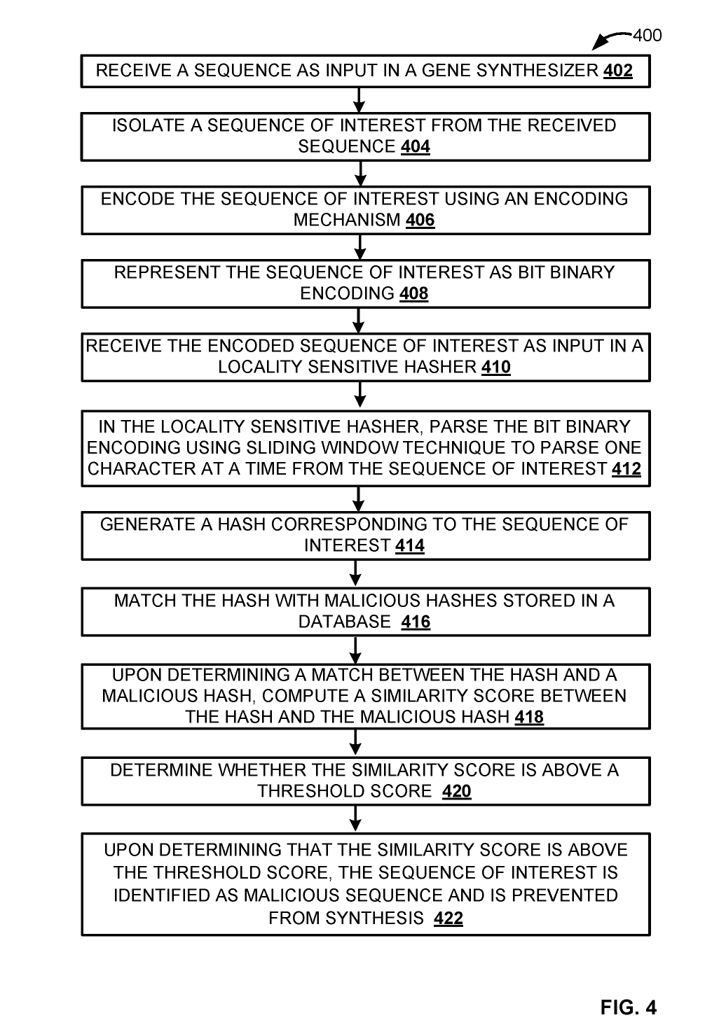

FIG. 4 is a flow chart illustrating process 400 to detect malicious sequence for gene synthesizer, according to one embodiment. At 402, a sequence is received as input in a gene synthesizer. At 404, a sequence of interest is isolated from the received sequence. At 406, the sequence of interest is encoded using an encoding mechanism. At 408, the sequence of interest is represented as bit binary encoding. At 410, the encoded sequence of interest is received as input in a locality sensitive hasher. At 412, in the locality sensitive hasher, the bit binary encoding is parsed using sliding window technique to parse one character at a time from the sequence of interest. At 414, a hash is generated corresponding to the sequence of interest. At 416, the hash is matched with malicious hashes stored in a database. At 418, upon determining a match between the hash and a malicious hash, a similarity score is computed between the hash and the malicious hash. At 420, it is determined whether the similarity score is above a threshold score. Upon determining that the similarity score is above the threshold score, at 422, the sequence of interest is identified as malicious sequence and is prevented from synthesis.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

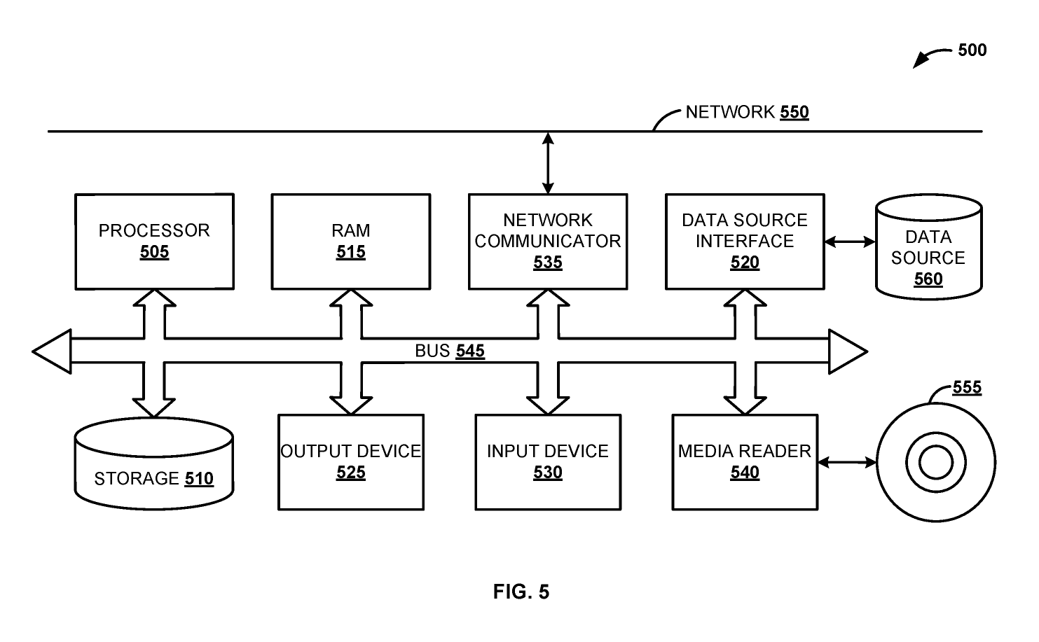

FIG. 5 is a block diagram of an exemplary computer system 500. The computer system 500 includes a processor 505 that executes software instructions or code stored on a computer readable storage medium 555 to perform the above-illustrated methods. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
represent a sequence of interest as bit binary encoding;
receive the sequence of interest as input in a locality sensitive hasher;
in the locality sensitive hasher, parse the bit binary encoding using sliding window technique to parse one character at a time from the sequence of interest;
generate a hash corresponding to the sequence of interest;
match the hash with a plurality of malicious hashes stored in a database;
upon determining a match between the hash and a malicious hash, compute a similarity score between the hash and the malicious hash;
determine whether the similarity score is above a threshold score; and
upon determining that the similarity score is above the threshold score, the sequence of interest is identified as malicious sequence and prevented from synthesis.

2. The non-transitory computer-readable medium of claim 1, further comprises instructions which when executed by the computer further cause the computer to:
receive a sequence as input in a gene synthesizer;
isolate the sequence of interest from the sequence; and
encode the sequence of interest using an encoding mechanism.

3. The non-transitory computer-readable medium of claim 2, wherein isolate the sequence further comprises instructions which when executed by the computer further cause the computer to:
identify a primer and a suffix in the sequence; and
remove the primer and the suffix from the sequence to identify the sequence of interest.

4. The non-transitory computer-readable medium of claim 2, wherein isolate the sequence further comprises instructions which when executed by the computer further cause the computer to:
identify the sequence of interest including a start codon and a stop codon.

5. The non-transitory computer-readable medium of claim 1, further comprises instructions which when executed by the computer further cause the computer to:
upon determining that the similarity score is below the threshold score, the sequence of interest is identified as non-malicious sequence.

6. The non-transitory computer-readable medium of claim 1, wherein generating the hash further comprises instructions which when executed by the computer further cause the computer to:
parse a set of bits from the bit binary encoding;
match the set of bits with a previously stored set of bits in an array of bucket;
upon determining a match, add the parsed set of bits and a count of number of times matched to the array of bucket;
compute quartile values based on the array of bucket and the count of number of times matched; and
based on the bit binary encoding and quartile, generate the hash corresponding to the sequence of interest.

7. The non-transitory computer-readable medium of claim 6, further comprises instructions which when executed by the computer further cause the computer to:
upon determining that there is no match, add the set of bits to a new array of bucket.

8. A computer-implemented method of malicious sequence detection for gene synthesizer, the method comprising:
represent a sequence of interest as bit binary encoding;
receive the sequence of interest as input in a locality sensitive hasher;
in the locality sensitive hasher, parse the bit binary encoding using sliding window technique to parse one character at a time from the sequence of interest.
generate a hash corresponding to the sequence of interest;
match the hash with a plurality of malicious hashes stored in a database;
upon determining a match between the hash and a malicious hash, compute a similarity score between the hash and the malicious hash;
determine whether the similarity score is above a threshold score; and
upon determining that the similarity score is above the threshold score, the sequence of interest is identified as malicious sequence and prevented from synthesis.

9. The method of claim 8, further comprising:
receive a sequence as input in a gene synthesizer;
isolate the sequence of interest from the sequence; and
encode the sequence of interest using an encoding mechanism.

10. The method of claim 9, wherein isolate the sequence further comprising:
identify a primer and a suffix in the sequence; and
remove the primer and the suffix from the sequence to identify the sequence of interest.

11. The method of claim 9, wherein isolate the sequence further comprising:
identify the sequence of interest including a start codon and a stop codon.

12. The method of claim 8, further comprising:
upon determining that the similarity score is below the threshold score, the sequence of interest is identified as non-malicious sequence.

13. The method of claim 8, wherein generating the hash further comprising:
parse a set of bits from the bit binary encoding;
match the set of bits with a previously stored set of bits in an array of bucket;
upon determining a match, add the parsed set of bits and a count of number of times matched to the array of bucket;
compute quartile values based on the array of bucket and the count of number of times matched; and
based on the bit binary encoding and quartile, generate the hash corresponding to the sequence of interest.

14. The method of claim 13, further comprising:
upon determining that there is no match, add the set of bits to a new array of bucket.

15. A computer system for malicious sequence detection for gene synthesizer, comprising:
a computer memory to store program code; and
a processor to execute the program code to:
represent a sequence of interest as bit binary encoding;
receive the sequence of interest as input in a locality sensitive hasher;
in the locality sensitive hasher, parse the bit binary encoding using sliding window technique to parse one character at a time from the sequence of interest;
generate a hash corresponding to the sequence of interest;
match the hash with a plurality of malicious hashes stored in a database;
upon determining a match between the hash and a malicious hash, compute a similarity score between the hash and the malicious hash;
determine whether the similarity score is above a threshold score; and
upon determining that the similarity score is above the threshold score, the sequence of interest is identified as malicious sequence and prevented from synthesis.

16. The system of claim 15, wherein the encoding mechanism further executes the program code to:
receive a sequence as input in a gene synthesizer;
isolate the sequence of interest from the sequence; and
encode the sequence of interest using an encoding mechanism;

17. The system of claim 16, wherein isolate the sequence further executes the program code to:
identify a primer and a suffix in the sequence; and
remove the primer and the suffix from the sequence to identify the sequence of interest.

18. The system of claim 16, wherein isolate the sequence further executes the program code to:
identify the sequence of interest including a start codon and a stop codon as the sequence of interest.

19. The system of claim 15, wherein generating the hash further executes the program code to:
parse a set of bits from the bit binary encoding;
match the set of bits with a previously stored set of bits in an array of bucket;
upon determining a match, add the parsed set of bits and a count of number of times matched to the array of bucket;
compute quartile values based on the array of bucket and the count of number of times matched; and
based on the bit binary encoding and quartile, generate the hash corresponding to the sequence of interest.

20. The system of claim 19, wherein the processor further executes the program code to:
upon determining that there is no match, add the set of bits to a new array of bucket.
